(19) United States
(12) Patent Application Publication
(10) Pub. No.: US 2023/0045817 A1
(43) Pub. Date: Feb. 16, 2023

(54) COSMETIC COMPONENT SPRAYING DEVICE

(71) Applicant: Panasonic Intellectual Property Management Co., Ltd., Osaka (JP)

(72) Inventors: Akira KATAOKA, Hyogo (JP); Aya ISHIHARA, Osaka (JP); Hiroyuki INOUE, Shiga (JP)

(21) Appl. No.: 17/794,160

(22) PCT Filed: Oct. 27, 2020
(86) PCT No.: PCT/JP2020/040183

§ 371 Date: Jul. 20, 2022

(30) Foreign Application Priority Data
Feb. 21, 2020 (JP) 2020-028777

(51) Int. Cl. A45D 34/04; B05B 5/03; B05B 5/00

(52) U.S. Cl. CPC A45D 34/04; B05B 5/03; B05B 5/001; A45D 20/12

(57) ABSTRACT

A cosmetic component spraying device according to the present disclosure includes a mixture having a cosmetic component and a matrix, and an air blower that blows air to the cosmetic component. The cosmetic component spraying device according to the present disclosure includes a laser irradiation unit that irradiates the mixture with a laser light, and a capturing electrode having the same polarity as a polarity of the cosmetic component. According to the cosmetic component spraying device according to the present disclosure, a cosmetic component can be suitably fixed to a target part.

### TECHNICAL FIELD

The present disclosure relates to a cosmetic component spraying device.

### BACKGROUND ART

There are known a mixture having a cosmetic component and a matrix, a gas in contact with the mixture, and an air blower that blows the cosmetic component and the gas. Patent Literature 1 discloses a configuration of a hair dryer having a cosmetic component, a gas in contact with the cosmetic component, and an air blower that blows the cosmetic component and the gas.

### CITATION LIST

### Patent Literature

PTL 1: Unexamined Japanese Patent Publication No. 2019-111158

### SUMMARY OF THE INVENTION

In the hair dryer of Patent Literature 1, a nonwoven fabric to which a cosmetic component is attached is arranged in an air blowing passage of the hair dryer, and the cosmetic component is sprayed by an air flow generated by operation of the air blower. Meanwhile, there is a case where hair or skin which is a spraying target part is charged. In this case, even if an uncharged cosmetic component is sprayed, the cosmetic component might not be fixed to the spraying target.

The present disclosure relates to an invention for solving the above problem, and provides a cosmetic component spraying device by which a cosmetic component is suitably fixed to a target part.

The cosmetic component spraying device according to the present disclosure is a cosmetic component spraying device that has a mixture having a cosmetic component and a matrix, and an air blower that blows air to the cosmetic component, the cosmetic component spraying device including: a laser irradiation unit that irradiates the mixture with a laser light; and a capturing electrode having the same polarity as a polarity of the cosmetic component.

According to the cosmetic component spraying device according to the present disclosure, a cosmetic component can be suitably fixed to a target part.

### BRIEF DESCRIPTION OF THE DRAWINGS

FIG. 1 is a side view showing an example of a cosmetic component spraying device according to an exemplary embodiment.

FIG. 2 is a sectional view of the cosmetic component spraying device illustrated in FIG. 1.

FIG. 3 is a block diagram showing electrical connection of the cosmetic component spraying device illustrated in FIG. 1.

FIG. 4 is a view showing an example of a laser optical path of the cosmetic component spraying device illustrated in FIG. 1.

FIG. 5 is a graph showing a temperature rise of a cosmetic component and a matrix caused by a laser.

FIG. 6 is a graph showing an absorption spectrum of a substance contained in a mixture.

### DESCRIPTION OF EMBODIMENT

(One example of applicable mode of cosmetic component spraying device)

(1) A cosmetic component spraying device according to the present disclosure is a cosmetic component spraying device that has a mixture having a cosmetic component and a matrix, and an air blower that blows air to the cosmetic component, the cosmetic component spraying device including: a laser irradiation unit that irradiates the mixture with a laser light; and a capturing electrode having the same polarity as a polarity of the cosmetic component.

According to the above-described cosmetic component spraying device, a substance having a polarity different from the polarity of the cosmetic component is captured by the capturing electrode. Therefore, the cosmetic component is suppressed from losing electric charges and entering an electrically neutral state, resulting in suitably fixing the cosmetic component to a target part.

(2) An example of the cosmetic component spraying device further includes a mist generation unit that generates mist.

According to the above-described cosmetic component spraying device, since particles are formed by the mist and the cosmetic component, stability of the cosmetic component is improved.

(3) According to an example of the cosmetic component spraying device, the capturing electrode is a discharge electrode of the mist generation unit.

According to the above-described cosmetic component spraying device, since the capturing electrode and the discharge electrode are used in common, a cosmetic component can be suitably fixed to a target part with a simple configuration.

(4) According to an example of the cosmetic component spraying device, the mist generation unit further includes a liquid supply unit that supplies a liquid to the discharge electrode, and generates mist having the same polarity as the polarity of the cosmetic component from the liquid.

According to the above-described cosmetic component spraying device, since the mist has the same polarity as the cosmetic component, the cosmetic component is less likely to enter an electrically neutral state, i.e., a state having no electric charge.

(5) According to an example of the cosmetic component spraying device, the liquid supply unit is configured with at least one of a Peltier element and a tank that stores a liquid.

According to the above-described cosmetic component spraying device, an appropriate liquid supply unit can be configured according to a supply amount of a liquid.

### EXEMPLARY EMBODIMENT

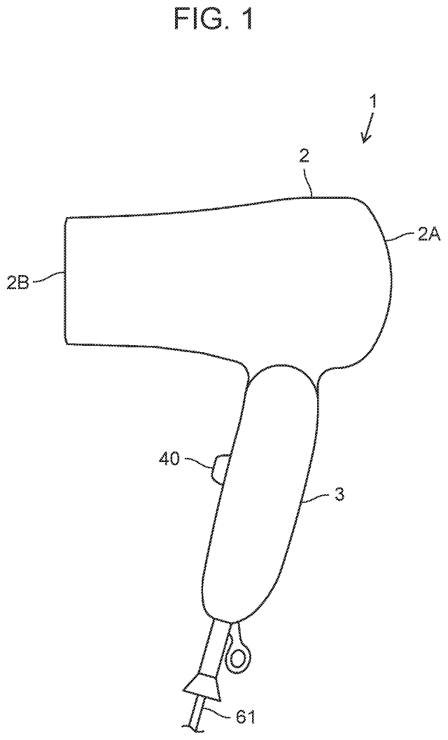

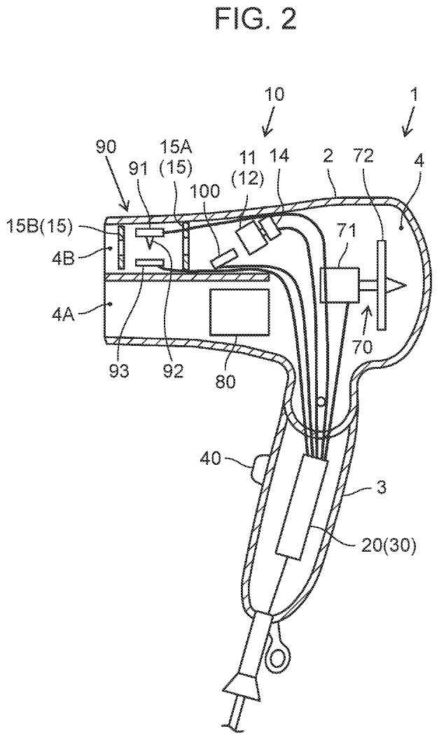

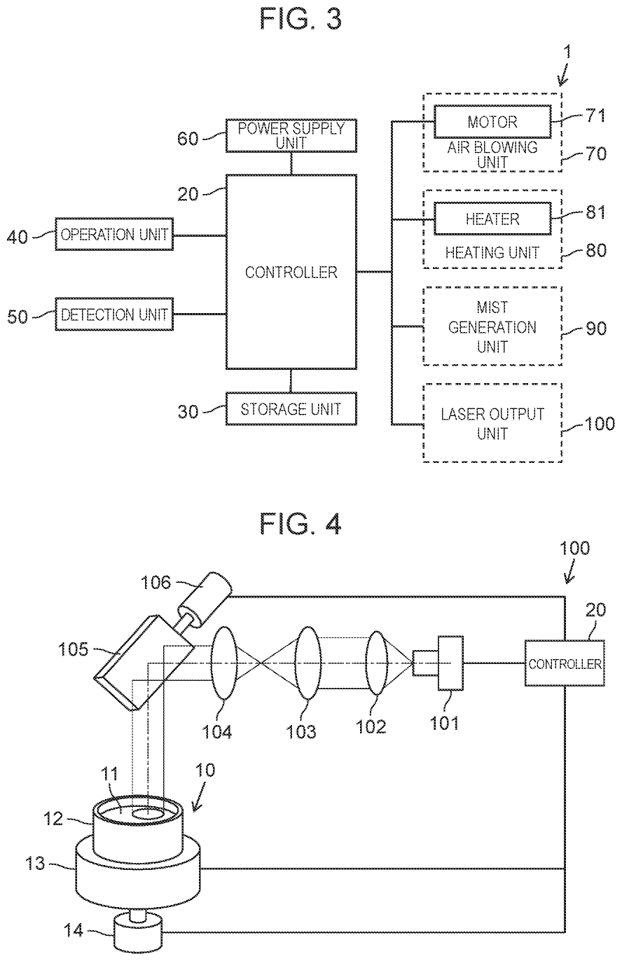

In the following, cosmetic component spraying device 1 of an exemplary embodiment will be described with reference to FIGS. 1 to 4. Cosmetic component spraying device 1 supplies at least one of a cosmetic component and air blow to a target part of a user. The target part is, for example, the user's head hair and skin. Cosmetic component spraying device 1 is, for example, a hair dryer. Hereinafter, cosmetic component spraying device 1 will be described as a hair dryer. Cosmetic component spraying device 1 includes housing 2 that constitutes an outer appearance of the device and houses at least one of the other elements that constitute cosmetic component spraying device 1, and grip unit 3 that is gripped by the user during use. Housing 2 and grip unit 3 are preferably coupled to each other by a coupling part configured to be able to change a position of housing 2 with respect to grip unit 3.

Housing 2 and grip unit 3 are made of an arbitrary material having excellent heat resistance. In one example, the material constituting housing 2 and grip unit 3 is polycarbonate. Housing 2 includes suction port 2A through which outside air flows in and discharge port 2B through which a cosmetic component or air is discharged to the outside. Suction port 2A preferably includes a filter that prevents dust or the like in the outside air from entering housing 2. Suction port 2A and discharge port 2B each have, for example, an oval shape.

Housing 2 includes flow path 4 in which a flow of fluid is formed. Flow path 4 connects suction port 2A and discharge port 2B. Flow path 4 includes first flow path 4A through which mainly gas passes and second flow path 4B through which mainly a cosmetic component passes. In one example, first flow path 4A and second flow path 4B each have a length half a length of the entire flow path 4.

Cosmetic component spraying device 1 includes cosmetic component output unit 10. Cosmetic component output unit 10 includes mixture 11 and base 12 that supports mixture 11. Cosmetic component output unit 10 further includes cooling unit 13 that cools mixture 11 and driving unit 14 that moves a position of mixture 11. At least a part of cosmetic component output unit 10 is provided in second flow path 4B.

Mixture 11 includes a cosmetic component. The cosmetic component is a component having suitable action on hair and skin. Among examples of suitable action are moisturization, repair and gloss formation. The cosmetic component contains at least one of amino acids such as glycine, alanine, valine, leucine, isoleucine, phenylalanine, proline, hydroxyproline, threonine, serine, tyrosine, methionine, tryptophan, cystine, cysteic acid, arginine, histidine, lysine, hydroxylysine, and glutamic acid; higher fatty acids such as capric acid, lauric acid, myristic acid, palmitic acid, stearic acid, behenic acid, oleic acid, coconut oil fatty acid, isostearic acid, isopalmitic acid, and α-linolenic acid; hydrocarbon oils such as liquid paraffin, liquid isoparaffin, vaseline, squalene, and squalane; natural oils such as camellia oil, macadamia oil, corn oil, olive oil, avocado oil, castor oil, safflower oil, jojoba oil, sunflower oil, rapeseed oil, sesame oil, soybean oil, and meadow foam oil; organic acids such as malic acid, tannic acid, citric acid; lipids such as cholesterol, ceramide 1, ceramide 2, ceramide 3, ceramide 1A, ceramide 611, 18-methyleicosanoic acid, cholesterol sulfate, triglyceride, and lysolecithin; higher alcohols such as stearyl alcohol and cetyl alcohol; esters such as beeswax, candelilla wax, carnarba wax, isopropyl palmitate, myristyl lactate, 2-ethylhexyl stearate, wax esters, isopropyl myristate, myristyl myristate, octyl palmitate, stearyl stearate, isocetyl stearate, isononyl isononanoate, isotridecyl isononanoate, hydrogenated castor oil stearate, hydroxystearate hydrogenated castor oil, glyceryl tri(2-ethylhexanoate), pentaerythritol tetra(2-ethylhexanoate), neopentyl glycol dicaprate, diglyceryl diisostearate, dipentaerythritol, and esters with mixed fatty acids such as hydroxystearic acid/stearic acid/rosin acid; silicones such as dimethylpolysiloxane, amino-modified silicone, polyether modified, and cationized silicone; antioxidants such as polyphenols, vitamins and fullerenes; polysaccharides such as D-galactose, D-glucuronic acid, L-fucose, D-mannose, chitosan, and cationized polysaccharides; humectants such as glycerin, water, xanthan gum, panthenol, sucrose, glucose, fructose, sorbitol, mannitol, xylitol, maltitol, diglycerin, triglycerin, propylene glycol, dipropylene glycol, polypropylene glycol, triethylene glycol, tetraethylene glycol, polyethylene glycol, 1,2-butylene glycol, 1,3-butylene glycol, 1,2-pentanediol, hexylene glycol, erythritol, polyoxyethylene methyl glucoside, and polyvinyl alcohol; sphingosines such as dihydrosphingosine, phytosphingosine, and hydroxy caproyl phytosphingosine; peptides such as collagen PPT, keratin PPT, silk PPT, pearl PPT, milk PPT, soybean PPT, cationized PPT derivatives of the above PPT, acylated PPT derivatives, silylated PPT derivatives, and ethyl esterified PPT derivatives; proteins such as sesame protein, protein obtained from seeds of leguminous plants, rice protein, protein obtained from shells having pearl layers or pearls, and protein obtained from silk; extracts such as ginseng extract, rice germ extract, fucales extract, camellia extract, aloe extract, shell ginger extract, and chlorella extract; metals such as zinc, magnesium, and calcium; polymer compounds such as cationized cellulose, hydroxylated cellulose, highly polymerized polyethylene oxide, and cationized synthetic polymer; anti-dandruff agents such as zinc pyrithione and benzalkonium chloride; and antibacterial agents such as dipotassium glycyrrhizinate.

Mixture 11 further includes a matrix. The matrix absorbs a laser light having a predetermined wavelength to increase a temperature thereof, resulting in evaporating the cosmetic component constituting mixture 11 and applying an electric charge. In one example, materials constituting the matrix are cerium oxide and lutein. More preferably, the material constituting the matrix is cerium oxide.

Base 12 supports mixture 11. A shape of base 12 is, for example, a bottomed cylindrical shape configured such that at least a part of mixture 11 is exposed. A part exposed from base 12 is irradiated with a laser light. A material constituting base 12 preferably has conductivity, and is stainless steel in one example. Cooling unit 13 is configured with, for example, a Peltier element, and suppresses mixture 11 and base 12 from having an excessive temperature rise, the mixture and the base being temperature-elevated by irradiation with a laser light. Driving unit 14 is configured with, for example, a motor, and changes the position of mixture 11 irradiated with a laser light by rotation of the motor.

Cosmetic component output unit 10 further includes movement electrode 15. Movement electrode 15 electrostatically attracts a cosmetic component having an electric charge to move the cosmetic component in flow path 4. An example of a shape of movement electrode 15 is an annular shape corresponding to a shape of flow path 4. A material constituting movement electrode 15 is, for example, stainless steel. Movement electrode 15 is arranged in a state where a straight line passing through the center of movement electrode 15 intersects base 12 and is not the same as an optical axis output by laser irradiation unit 100. A plurality of movement electrodes 15 is provided, for example, in second flow path 4B. Movement electrode 15 is provided on a downstream side of flow path 4 with respect to mixture 11. A plurality of movement electrodes 15 may be provided. Preferably, among the plurality of movement electrodes 15, movement electrode 15B is configured to have a potential whose absolute value is larger than a potential of movement electrode 15A provided upstream of movement electrode 15B in second flow path 4B. In one example, movement electrode 15B includes a material having a potential higher than that of a material of movement electrode 15A.

Cosmetic component spraying device 1 further includes controller 20, storage unit 30, operation unit 40, detection unit 50, power supply unit 60, air blowing unit 70, heating unit 80, mist generation unit 90, and laser irradiation unit 100. At least one of controller 20, storage unit 30, operation unit 40, detection unit 50, power supply unit 60, air blowing unit 70, heating unit 80, mist generation unit 90, and laser irradiation unit 100 is held inside housing 2.

Controller 20 is configured with an arithmetic processing unit that executes a control program. The arithmetic processing unit is configured with, for example, at least one or both of a central processing unit (CPU) and a micro processing unit (MPU). Controller 20 is configured to be able to communicate with storage unit 30, operation unit 40, detection unit 50, air blowing unit 70, heating unit 80, mist generation unit 90, and laser irradiation unit 100 in a wireless or wired manner Controller 20 starts control when, for example, electric power is supplied from power supply unit 60 and an operation signal is input from operation unit 40. Preferably, controller 20 is provided at a place away from heating unit 80 as a heat generation source. In one example, controller 20 is provided at a place corresponding to grip unit 3. Storage unit 30 stores program information for executing various controls to be executed by controller 20. Storage unit 30 includes, for example, a non-volatile memory and a volatile memory. Storage unit 30 is provided in the same control circuit as, for example, controller 20.

Operation unit 40 outputs an operation signal by operation by the user to controller 20, for example. The operation signal includes a signal for switching on and off of controller 20 or a signal for executing, by controller 20, output change of at least one of air blowing unit 70, heating unit 80, mist generation unit 90, and laser irradiation unit 100. A part of operation unit 40 is configured to protrude toward the outside of housing 2 for user's ease of operation. Operation unit 40 is configured with, for example, a button, a switch, and a dial. Operation unit 40 may be configured with a touch panel. Operation unit 40 is provided in, for example, grip unit 3.

Detection unit 50 detects various pieces of information on cosmetic component spraying device 1. A detection value detected by detection unit 50 is output to controller 20. Detection unit 50 detects, for example, temperature, the number of uses, a use time of cosmetic component spraying device 1, a remaining amount of power source of power supply unit 60, and a remaining amount of a cosmetic component of mixture 11. Controller 20 may be configured to perform control according to the detection value of detection unit 50.

Power supply unit 60 supplies electric power to controller 20, storage unit 30, operation unit 40, detection unit 50, air blowing unit 70, heating unit 80, mist generation unit 90, and laser irradiation unit 100. In the illustrated example, power supply unit 60 is an external power source such as a commercial power source. Power supply unit 60 may have a configuration of a secondary battery provided inside housing 2. In a case where power supply unit 60 is an external power source, cosmetic component spraying device 1 and power supply unit 60 are connected by power line 61.

Air blowing unit 70 attracts air through suction port 2A and discharges the air from discharge port 2B. Air blowing unit 70 includes motor 71 and fan 72. When motor 71 is driven to rotate fan 72, an air flow is generated in flow path 4. Motor 71 is controlled by controller 20. Air blowing unit 70 is located upstream of first flow path 4A and second flow path 4B in flow path 4, and supplies air to both first flow path 4A and second flow path 4B.

Heating unit 80 heats air in housing 2 to produce hot air. The hot air is, for example, air within a range between 100° C. and 120° C. inclusive. Heating unit 80 includes heater 81. Examples of heater 81 include a positive temperature coefficient (PTC) heater and an infrared heater. Heating unit 80 is provided, for example, in first flow path 4A. Controller 20 controls output of heater 81.

Mist generation unit 90 supplies mist to a cosmetic component having an electric charge. The mist represents a state in which liquid is formed in fine particles. Mist generation unit 90 includes liquid supply unit 91, discharge electrode 92, and counter electrode 93. Liquid supply unit 91 supplies liquid to discharge electrode 92. An example of the liquid is water. In a first example, liquid supply unit 91 is configured with a Peltier element, and supplies liquid by condensation of moisture contained in air. In a second example, liquid supply unit 91 includes a tank that stores liquid and a pump, and supplies the liquid in the tank by driving of the pump. When a voltage is applied to discharge electrode 92 and counter electrode 93, the liquid supplied by liquid supply unit 91 is electrostatically cleaved to form mist. Mist generation unit 90 is provided in second flow path 4B. Discharge electrode 92 has a function as a capturing electrode that captures, by discharge electrode 92 itself or a charged component generated by discharging of discharge electrode 92, a charged component derived from air in housing 2, the charged component being generated by irradiation of a laser light. This prevents a cosmetic component having an electric charge from entering a state of having no electric charge. Discharge electrode 92 and the mist are negatively charged, for example.

Laser irradiation unit 100 irradiates mixture 11 with a laser light. Laser irradiation unit 100 is controlled by controller 20. Laser irradiation unit 100 includes light emitting unit 101, first lens 102, second lens 103, third lens 104, galvano mirror 105, and adjustment unit 106. Light emitting unit 101 is configured with, for example, a semiconductor laser, and outputs a laser light when a current flows. A wavelength of the laser light is preferably in an ultraviolet region. The wavelength of the laser light is, for example, 365 nm, 385 nm, 395 nm, 405 nm, or 450 nm. An energy density and a range of the laser light with which mixture 11 is irradiated are determined by the plurality of first lenses 102, second lenses 103, and third lenses 104. The laser light output from light emitting unit 101 is reflected by galvano mirror 105, so that a predetermined position of mixture 11 is irradiated with the laser light. Adjustment unit 106 is configured with, for example, an actuator or a motor, and adjusts a position of mixture 11 so as to be irradiated with the laser light by changing a relative orientation of galvano mirror 105.

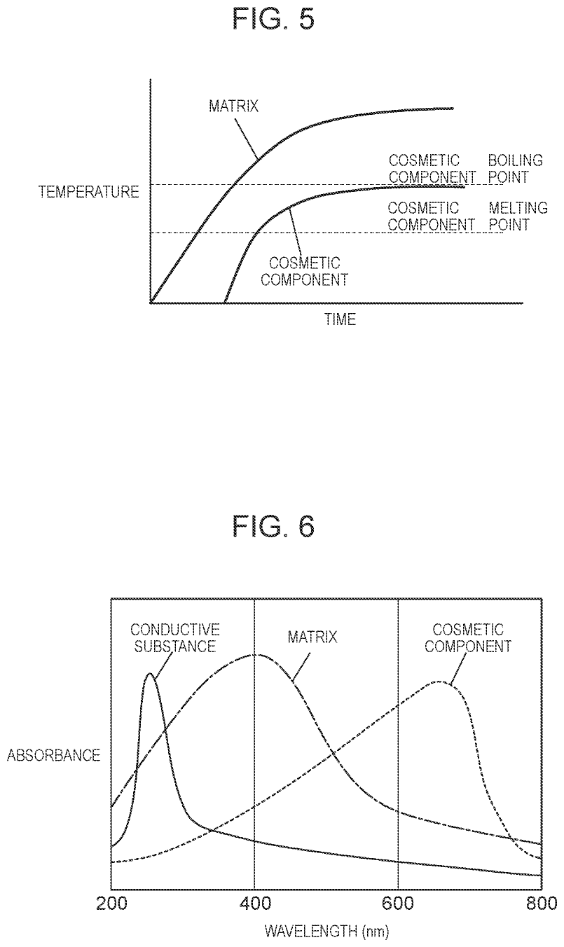

A preferred composition of mixture 11 will be described with reference to FIGS. 5 and 6. As shown in FIG. 5, a material constituting the matrix preferably has a melting point and a boiling point higher than those of the cosmetic component. In addition, the matrix preferably has a larger temperature increase per predetermined time than the cosmetic component. In this case, the cosmetic component can be quickly evaporated so as to be imparted an electric charge.

The cosmetic component and the matrix are in the same ratio in one example. Any one ratio of the cosmetic component and the matrix may be large. The cosmetic component and the matrix may be solid or liquid. In a case of a solid, the cosmetic component and the matrix can be fixed inside cosmetic component spraying device 1. In a case of a liquid, the cosmetic component and the matrix can be easily replaced. As the cosmetic component and the matrix, it is preferable to select those having sufficiently confirmed biological safety. The cosmetic component and the matrix may be fixed by adhesion with a binder or the like, or the cosmetic component may be melted into the matrix and then solidified by cooling. In a case where the cosmetic component and the matrix are not electrically conductive, an electrically conductive substance may be added to be solidified. The conductive substance imparts an electric charge to the cosmetic component, for example, by applying or removing electrons to or from the cosmetic component. The conductive substance is, for example, carbon black or metal. In a case where mixture 11 is not conductive, the cosmetic component is electrically neutral when evaporated, so that the cosmetic component may not be suitably released from discharge port 2B.

As shown in FIG. 6, the conductive substance, the matrix, and the cosmetic component contained in mixture 11 each preferably have different absorbance. In one example, the conductive substance is excellent in absorption of a laser light having a wavelength around 250 nm. The matrix is excellent in absorption of a laser light having a wavelength around 400 nm. The cosmetic component is excellent in absorption of a laser light having a wavelength around 650 nm. For this reason, for example, when mixture 11 is irradiated with a laser light of around 400 nm, a heating rate of the matrix contained in a large amount in mixture 11 is high, so that the cosmetic component can be suitably heated. When light emitting unit 101 outputs a laser light having a wavelength of around 400 nm, electric charges can be suitably imparted to the cosmetic component.

A method for using cosmetic component spraying device 1 of the exemplary embodiment will be described.

When the user operates operation unit 40 of cosmetic component spraying device 1, electric power supply from power supply unit 60 is started to start control by controller 20. Controller 20 controls light emitting unit 101 of laser irradiation unit 100 to cause light emitting unit 101 to emit a light under a predetermined condition. The predetermined condition includes a wavelength of the laser light, a pulse width of light emitting unit 101, and an irradiation area of mixture 11. The predetermined condition is stored in storage unit 30, for example, and controller 20 refers to the condition stored in storage unit 30. In one example, the wavelength of the laser light is 405 nm, the pulse width is 0.1 seconds, and a spot diameter is 0.1 mm for mixture 11.

When mixture 11 is irradiated with the laser light from light emitting unit 101, the temperature of the matrix increases because the matrix of mixture 11 suitably absorbs the laser light. As the temperature of the matrix increases, the temperature of the cosmetic component increases, and the cosmetic component is released from mixture 11 when the temperature reaches the boiling point. The cosmetic component is in a state, for example, of being negatively charged. Emission of the laser light also excites air around mixture 11. Since the air contains a large amount of nitrogen, a positively charged nitrogen-based compound is generated. Controller 20 changes the position of mixture 11 to be irradiated with the laser light by controlling at least one of driving unit 14 and adjustment unit 106.

Controller 20 controls air blowing unit 70 to generate a flow of gas flowing from suction port 2A to discharge port 2B. Furthermore, controller 20 positively charges movement electrode 15. Because of having a negative electric charge, the cosmetic component is attracted to movement electrode 15A. Movement electrode 15A and the nitrogen-based compound repel each other because of both having positive electric charges. Therefore, the cosmetic component easily flows downstream in second flow path 4B. On the other hand, the nitrogen-based compound hardly flows downstream.

Controller 20 controls mist generation unit 90 to generate mist. The mist has the same electric charge as the cosmetic component. The mist and the cosmetic component are attracted by movement electrode 15B provided further downstream, and are discharged from discharge port 2B. The mist and the cosmetic component released from discharge port 2B come into contact with the user's hair and skin to exhibit a predetermined effect.

(Modifications)

The description of the exemplary embodiment exemplifies an applicable mode of the cosmetic component spraying device according to the present disclosure, and is not intended to limit the mode of the device. The present disclosure can assume, in addition to the exemplary embodiment, following modifications of the exemplary embodiment, and any mode acquired by combining at least two modifications which do not contradict with each other, for example.

The conductive substance may be provided on base 12. The conductive substance provided on base 12 imparts a negative electric charge to the cosmetic component, for example. Therefore, the cosmetic component can be more efficiently released from discharge port 2B. In another example, a negative electric charge is imparted to a positively charged nitrogen-based compound generated by laser light irradiation with air. This makes the nitrogen-based compound be neutrally charged, and causes electrons to move between the nitrogen-based compound and the cosmetic component, resulting in suppressing the electric charge of the cosmetic component from becoming neutral.

The cosmetic component spraying device according to the present disclosure can be used in hair care devices and skin care devices for home and business use.

### REFERENCE MARKS IN THE DRAWINGS

1 cosmetic component spraying device
4 flow path
11 mixture
12 base
15 movement electrode
60 power supply unit
90 mist generation unit
91 liquid supply unit
92 discharge electrode
100 laser irradiation unit

1. A cosmetic component spraying device that has a mixture having a cosmetic component and a matrix, and an air blower that blows air to the cosmetic component, the cosmetic component spraying device comprising:
a laser irradiation unit that irradiates the mixture with a laser light; and
a capturing electrode having a same polarity as a polarity of the cosmetic component.

2. The cosmetic component spraying device according to claim 1, further comprising a mist generation unit that generates mist.

3. The cosmetic component spraying device according to claim 2, wherein the capturing electrode is a discharge electrode of the mist generation unit.

4. The cosmetic component spraying device according to claim 3, wherein the mist generation unit includes a liquid supply unit that supplies a liquid to the discharge electrode, and
the mist generated by the mist generation unit has the same polarity as the polarity of the cosmetic component from the liquid.

5. The cosmetic component spraying device according to claim 4, wherein the liquid supply unit is at least one of a Peltier element and a tank that stores a liquid.
